(19) United States
(12) Patent Application Publication
(10) Pub. No.: US 2008/0060183 A1
(43) Pub. Date: Mar. 13, 2008

(54) Diesel engine water elbow removal tool

(76) Inventor: Junior Edmann Walker, Flatwoods, KY (US)

Correspondence Address: Junior E. Walker, 86 Bug Barn Road, Flatwoods, KY, 41139, US

(21) Appl. No.: 11/973,739

(22) Filed: Oct. 11, 2007

Related U.S. Application Data
(63) Continuation-in-part of application No. 11/300,361, filed on Dec. 15, 2005, now abandoned.

(51) Int. Cl. B23P 19/04

(52) U.S. Cl. 29/255

(57) ABSTRACT

The invention comprises a means wherein the water elbows of locomotion engines and other lager diesel engines can be removed with a slide hammer by way of attachments. That can be attached to the water elbows.

This invention is a continuation in part of an application entitled Diesel Engine Water Elbow Removal Tool, application Ser. No. 11/300,361, Filed Dec. 15, 2005 and was abandoned due to the broadness of the claims and the descriptions plus other objections. This invention shows improvements over the above application and more detailed descriptions where in narrower claims can be written.

### BACKGROUND OF INVENTION

Diesel Engine Water Elbow Removal Tool

Lager diesel engines such as those used by the railroads for locomotives comprise multiple water elbows that transfer coolant water from the engine block to the engine head. The elbows are installed with a vertical segment extending into the engine block with flexible O-rings located around the segment to seal the water from leaking around the elbow, the elbow having a tube-like structure on its vertical end. The horizontal end of the elbow having a right angle comprises a flange having two bolts and an o-ring gasket, said bolts threaded into the engine head.

When an engine is operated for a long period of time without removal of these elbows, they freeze to the engine head in a recessed area where the flange bolts to the head. Sometimes it takes from forty-five (45) minutes up to four (4) hours to remove them.

This invention will show a tool for removing them in less than thirty (30) minutes, even when they are frozen or locked in place where they can't be removed without using a hammer to loosen them up, which sometimes doesn't work or without using a pry bar or some other means to remove them. The invention comprises an attachment that can be threaded into a slide hammer, which acts as a puller for the elbows. One such attachment uses the bolt holes of the flange with pins extending into the holes where the slide hammer can pull the elbow from the engine head.

This invention will further show means of installing these elbows by using the slide hammer to drive the elbow into a recessed area of the engine head. It will show improvements over prior art including the aforementioned application.

### PRIOR ART

Slide hammers are used in many applications, such as bearing pullers, auto body dents, etc. They can be purchased at most auto parts stores or tool supply stores. They normally come with standard attachments. To remove the water elbows from large diesel engines such as locomotive engines, it requires a special attachment such as the one shown in this invention. The slide hammer has little value without the attachments. To my knowledge, no attachments will work on the water elbows except this special attachment of this invention.

Pat. Nos. 4,675,968 is typical of the many uses of a slide hammer use such as a wheel hub, lawn mower blade or a wheel or disc.

### SUMMARY OF INVENTION

This invention comprises a diesel engine water elbow removal tool attachment that can be housed to a slide hammer. The attachment mates with segments of the water elbows and is threaded to the slide hammer. The attachment can be used to install and remove the elbows.

This invention will be better understood when studied in conjunction with these drawings and written descriptions.

### BRIEF DESCRIPTIONS OF THE DRAWINGS

FIG. 1 Shows a water elbow housed to an engine.

FIG. 2 Shows a slide hammer and an attachment for said slide hammer.

FIG. 3 Is taken from line 3-3 of FIG. 1

FIG. 4 Is a view showing the face of the attachment.

FIG. 5 Is taken from line 5 of FIG. 4

FIG. 6 Is a plan view of a slide hammer attachment.

FIG. 7 Is taken from line 7-7 of FIG. 6

FIG. 8 Is taken from line 8 of FIG. 7

### DETAILED DESCRIPTIONS OF THE INVENTION

This invention comprises an engine block 1 and an engine head 2 having a water elbow 3 passing from the engine block 1 in a vertical position and making a right angle and passing to the engine head 2 in a horizontal position, the elbow 3 having a flange 5 that requires two bolts (not shown but is well known to those skilled in the art) that are threaded through holes 4 to the engine head 2.

An attachment 11 can be attached by way of pins 13 to holes 4. Attachment 11 comprises a threaded segment 15 that can be threaded to a slide hammer rod 10 by way of segment 14 of the slide hammer. A hammer 12 can be used to pull the elbows from the engine block 1 by attaching the pins 13 to holes 14. The slide hammer 12 is moved on a slide hammer rod 10 between stops 16 and 17 to impact against stop 16.

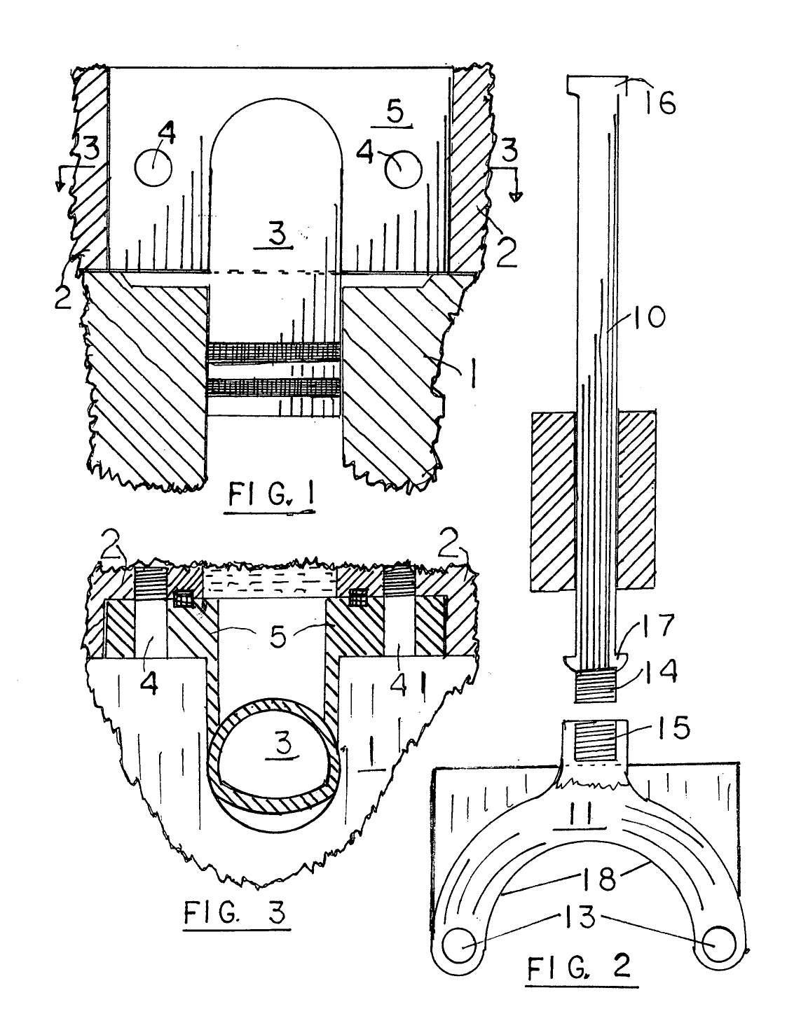

The attachment 11 is made from a plate like structure having a saddle like cut out 18 at attachment 11's bottom end and has a pin 13 at each side of said cut out 18 as shown in FIG. 2. The pins are pressed into and passes through and extends through the structure an amount equal to the elbow flange 5.

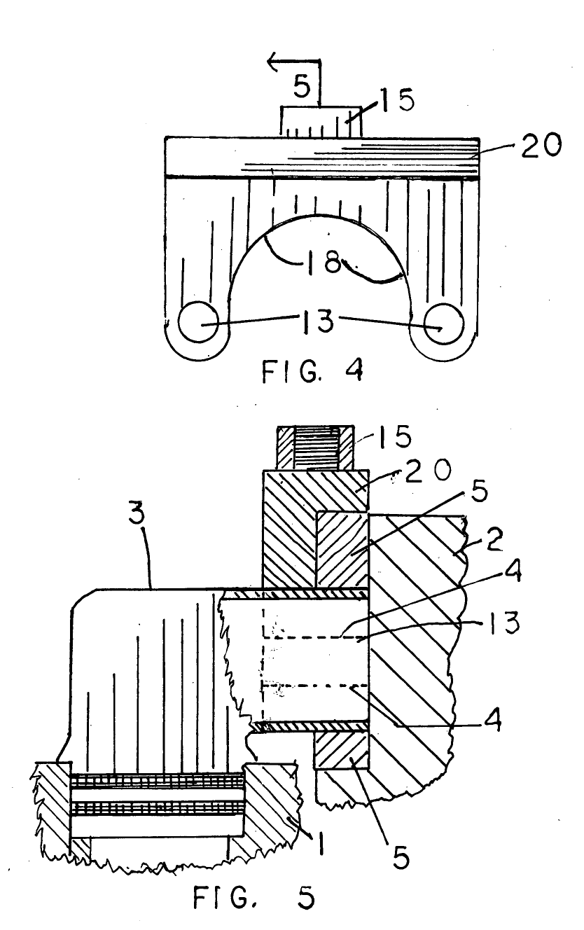

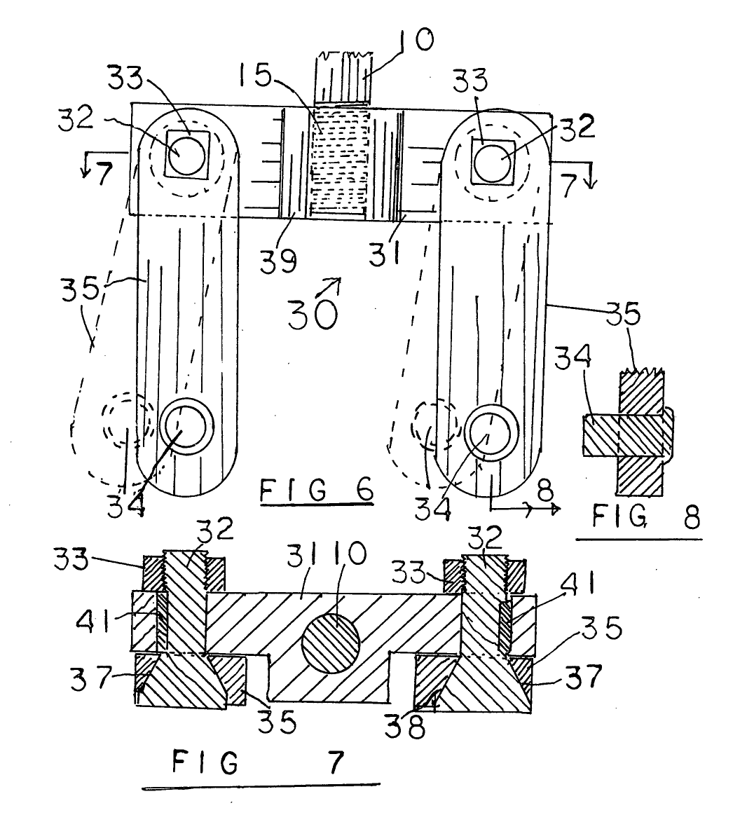

Shown by FIG. 4 and FIG. 5, a flange 20 is shown to overlap the elbow flange 5. This flange 20 is used to cover the full width of the top of flange 5. This allows the slide hammer to be used as a driver to install the water elbow 3 without damage to the flange because of the large surface area of the flange 5 as opposed to using the pin's 13 as an anchor to drive the elbow into the recessed area of the engine head 2.

Where an engine 1 elbows 3 flange 4 spacing changes with different engines, an adjustable attachment is shown by FIG. 6 and 7. A cross bar 31 is shown with two arms 35 and pins 34 that can be attached to elbows flange 5. The pins extend through the arm 35 an amount equal to the water elbow flange 5 thickness.

A taper lock 32 is shown where the arm 35 and pins 34 can be locked at any position that they can be located to. The fastener comprises a 30 or 40 degree taper 37 as does the arm 35 having a mating taper 38 and when the nut 33 is tightened, it locks the arms 35 in a position that is desired a segment 15 is threaded where slide hammer 10 can be attached there to. The taper fastener is keyed 39 to cross bar 31.

The arms 35 form a saddle like structure that saddles the water elbow 3. The bottom of cross bar 31 houses a segment forming a right angle that can rest against the top 40 of flange 5 wherein the slide hammer 10 can be used to drive the flange 5 into the recessed area of head 2, thus installing the water elbow 3 into position where bolts (not shown) can be threaded to holes 4. When installing elbow 3, the fastener bolt nut 33 is loosened so that pins 34 can be disengaged from flange 5. This allows the installation segment 31 to rest against the top of flange 5.

In operation, the pins are placed into the flange bolt holes, then using the taper locks 32 to lock the arms 35 in a fixed position the slide hammer 10 can be used to remove the water elbows from the engine. When installing the water elbows the pins would not be engaged with the flange bolt holes 4. To make the invention the parts could be fabricated or casted from a good grade of steel. Then assembled as shown the pins 34 would be pressed into position and welded to the back side of the plate structure or arm 35.

What I claim as my invention is:

1. A diesel engine water elbow removal/installation tool where said engine comprises an engine block, an engine head, a plurality of water elbows said elbows having a vertical segment linking said elbow with said engine block and a horizontal segment having a flange said flange having two bolt holes linking said horizontal segment with said engine head; That said tool comprises: a slide hammer having an attachment said attachment comprising; a plat like structure, a saddle like cut out at the lower end of said structure, a pin housed at each side of said cut out, said pins housed at a right angle to said plate structure and passing through said plate, an installation flange at the top extending at a right angle to said structure, a threaded segment linking said attachment with said slide hammer and that said pins are spaced to mate with said elbow flange bolt holes and extend through said plates structure an amount equal to the thickness of said water elbow flange.

2. A diesel engine water elbow removal/installation tool where said engine comprises an engine block, an engine head, a plurality of water elbows said elbows having a vertical segment linking said elbow with said engine block and a horizontal segment having a flange said flange having two bolt holes linking said horizontal segment with said engine head; That said tool comprises: a slide hammer attachment said attachment comprising; a cross bar, a pair of adjustable arms linked with said cross bar, said linkage comprising; a female taper, a bolt fastener having a male taper and threaded nut, a key housed between said fastener and said cross bar, taper locking means between said cross bar and said arms, a pin at the bottom segment of each of said arms said pins housed at a right angle to said arms, that said pins extend through said arms an amount equal to the thickness of said water elbow flange, that said pins spacing between said arms is adjustable to mate with said water elbow flange bolt holes, an installation flange housed at a right angle to said water elbow flange, a threaded segment for linking said attachment to said slide hammer, and that said combination comprise means of installation and or removing said water elbows to or from said engine.
